(19) United States
(12) Patent Application Publication
(10) Pub. No.: US 2026/0187061 A1
(43) Pub. Date: Jul. 2, 2026

(54) NATURAL LANGUAGE QUERY PROCESSING USING VECTORIZED QUERY HISTORY

(71) Applicant: Teradata US, Inc., San Diego, CA (US)

(72) Inventor: John Douglas Frazier, Ramona, CA (US)

(73) Assignee: Teradata US, Inc., San Diego, CA (US)

(21) Appl. No.: 19/007,393

(22) Filed: Dec. 31, 2024

(51) Int. Cl. G06F 16/2452

(52) U.S. Cl. CPC G06F 16/24522

(57) ABSTRACT

A system includes a storage device and a plurality of processing nodes. At least one of the plurality of processing nodes receives a natural language query. The at least one processing node converts the natural language query to a database language syntax representation using a large language model (“LLM”) and converts the natural language query to a vectorized natural language representation using a vectorizing LLM. The at least one processing node converts query history to a vectorized query history representation using the vectorizing LLM. The at least one processing node compares the vectorized natural language representation to the vectorized query history representation and generates database syntax in response to the natural language query based on the comparison of the vectorized natural language representation to the vectorized query history representation. The at least one processing node executes the generated database syntax. A method and computer-readable medium are also disclosed.

### CROSS-REFERENCE TO RELATED PATENT APPLICATIONS

The present application is related to co-pending application Ser. No. XX/XXX,XXX filed on Dec. 31, 2024. This application is incorporated herein by reference, including its specification.

### BACKGROUND

Current conversational artificial intelligence (“AI”) interfaces often lack precision in aiding user interactions, relying on generic suggestions or preset questions, which may not align closely with user needs. One aspect of conversational AI is that the user interface for data requires a mechanism for the user to discover what data is available. Other integrated development environment (“IDE”) tools do this with side bar listings or other directory style mechanisms that may not be appropriate for a database conversational tool.

One popular approach is generating prompts or questions that users can ask to assist them on the conversational journey. Some vendors do this with selectable buttons for specific actions and others just advertise possible questions. Clearly, for a seasoned user this might be related to past conversations. However, for conversational AI against a database, more advanced techniques are needed for a desired level of precision. Another aspect of conversational AI against a database is that it is difficult to detect a wrong answer. The user may have had a short non-focused sort of question and the set of available data in tables may be too broad to refine and actually answer the question in a meaningful way or may be derived incorrectly, leading to wrong results.

Once the SQL for a query is generated the query can be explained and executed to validate that it is syntactically correct. However, the query may still be incorrect for that domain of knowledge and tables. Thus, additional techniques are needed in order to minimize the level of incorrectness.

Because database queries require higher levels of precision with regard to artificial intelligence, it would be desirable to implement internal database information to increase precision.

### SUMMARY

According to one aspect of the disclosure, a system may include a storage device. The system may further include a plurality of processing nodes. At least one of the plurality of processing nodes may receive a natural language query. The at least one of the plurality of processing nodes may convert the natural language query to a database language syntax representation using a large language model (“LLM”). The at least one of the plurality of processing nodes may convert the natural language query to a vectorized natural language representation using a vectorizing LLM. The at least one of the plurality of processing nodes may convert query history to a vectorized query history representation using the vectorizing LLM. The at least one of the plurality of processing nodes may compare the vectorized natural language representation to the vectorized query history representation. The at least one of the plurality of processing nodes may generate database syntax in response to the natural language query based on the comparison of the vectorized natural language representation to the vectorized query history representation. The at least one of the plurality of processing nodes may execute the generated database syntax.

According to another aspect of the disclosure, a method receiving, with a processor, a natural language query. The method may further include converting, with the processor, the natural language query to a database language syntax representation using an LLM. The method may further include converting, with the processor, the natural language query to a vectorized natural language representation using a vectorizing LLM. The method may further include converting, with a processor, query history to a vectorized query history representation using the vectorizing LLM. The method may further include comparing, with the processor, the vectorized natural language representation to the vectorized query history representation. The method may further include generating, with the processor, database syntax in response to the natural language query based on the comparison of the vectorized natural language representation to the vectorized query history representation. The method may further include executing, with the processor, the generated database syntax.

According to another aspect of the disclosure, a computer-readable medium may be encoded with a plurality of instructions executable by a processor. The plurality of instructions may include instructions to receive a natural language query. The plurality of instructions may include instructions to convert the natural language query to a database language syntax representation using an LLM. The plurality of instructions may include instructions to convert the natural language query to a vectorized natural language representation using a vectorizing LLM. The plurality of instructions may include instructions to convert query history to a vectorized query history representation using the vectorizing LLM. The plurality of instructions may include instructions to compare the vectorized natural language representation to the vectorized query history representation. The plurality of instructions may include instructions to generate database syntax in response to the natural language query based on the comparison of the vectorized natural language representation to the vectorized query history representation. The plurality of instructions may include instructions to execute the generated database syntax.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an example analytic environment.

FIG. 2 is a detailed block diagram of a processing node.

FIG. 3 is a detailed block diagram of an optimizer module.

FIG. 4 is a detailed block diagram of a parser module.

FIG. 5 is a block diagram of an example database management system using a large language model for natural language processing.

FIG. 6 is an example of a large language model determining various aspects of a user via a natural language query.

FIG. 7 is a block diagram of an example of a large language model being trained to handle vector embeddings.

FIG. 8 is a block diagram of an example database management system using a large language model for natural language processing using vector embeddings.

FIG. 9 is an operational flow diagram of an example training of a large language model.

FIG. 10 is an operational flow diagram of example processing of a natural language query using a large language model.

FIG. 11 is an operational flow diagram of an example training of a large language model with vector embeddings.

FIG. 12 is an operational flow diagram of example processing of a natural language query using a large language model capable of handling vector embeddings.

### DETAILED DESCRIPTION OF THE FIGURES

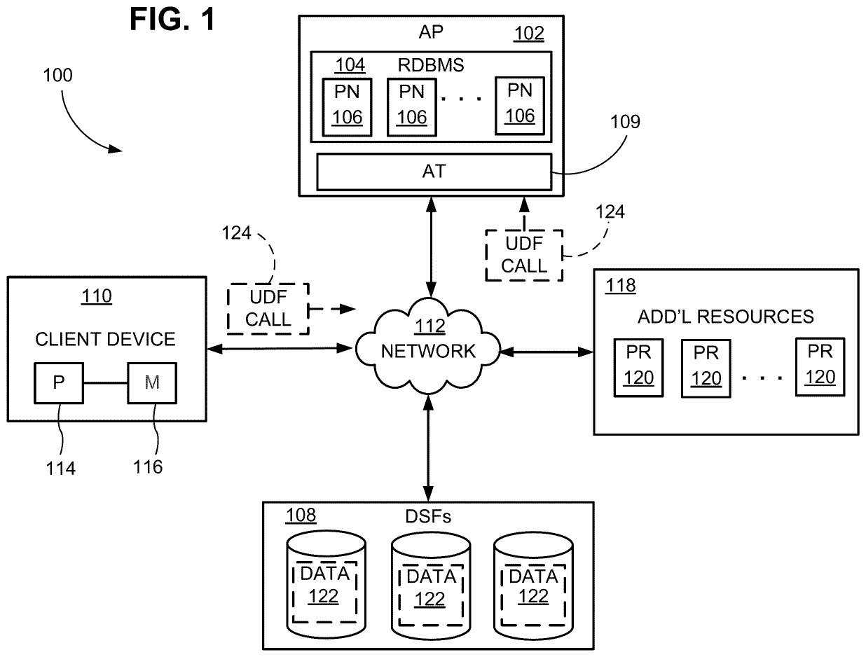

FIG. 1 is block diagram of an example analytic environment 100, In one example, the analytic environment 100 may include an analytic platform (“AP”) 102, such as Teradata Vantage. The analytic platform 102 may include one or more systems that may be used independently or with one another in conducting advanced analytics. The analytic platform 102 may include a relational database management system (“RDBMS”) 104. In one example, the RDBMS 104 may implement a parallel-processing environment to conduct database management. The RDBMS 104 may be a combination of software (e.g., computer program routines, subroutines, applications, etc.) and hardware (e.g., processors, memory, etc.). In the example of FIG. 1, the RDBMS 104 may be a massively parallel processing (MPP) system having a number of processing nodes 106. In alternative examples, the RDBMS 104 may implement a single processing node, such as in a symmetric multiprocessing (SMP) system configuration. The RDBMS 104 may include one or more processing nodes 106 used to manage the storage, retrieval, and manipulation of data in data storage facilities (DSFs) 108. The processing nodes 106 may manage the storage, retrieval, and manipulation of data included in a database.

The analytic environment 100 may include a client device 110 that communicates with the analytic platform 102 via a network 112. The client device 110 may represent one or more devices, such as a graphical user interface (“GUI”), that allows user input to be received. The client device 110 may include one or more processors 114 and memory(ies) 116, The network. 112 may be wired, wireless, or some combination thereof. The network 112 may be a cloud-based environment, virtual private network, web-based, directly-connected, or some other suitable network configuration. In one example, the client device 110 may run a dynamic workload manager (DWM) client (not shown).

The analytic environment 100 may also include additional resources 118. Additional resources 118 may include processing resources (“PR”) 120. In a cloud-based network environment, the additional resources 118 may represent additional processing resources that allow the analytic platform 102 to expand and contract processing capabilities as needed.

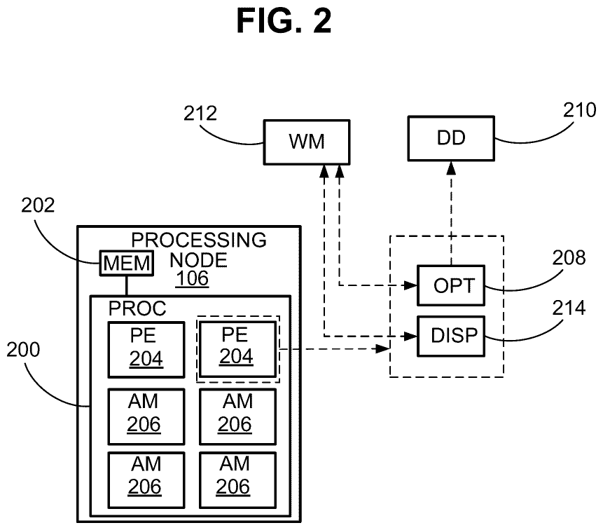

FIG. 2 is an example of a processing node 106, which may include one or more physical processors 200 and memory(ies) 202. The memory 202 may include one or more memories and may be computer-readable storage media or memories, such as a cache, buffer, random access memory (RAM), removable media, hard drive, flash drive or other computer-readable storage media. Computer-readable storage media may include various types of volatile and nonvolatile storage media. Various processing techniques may be implemented by the processors 200 such as multiprocessing, multitasking, parallel processing, and the like, for example.

The processing nodes 106 may include one or more other processing unit types such as parsing engine (PE) modules 204 and access modules (AM) 206. As described herein, each module, such as the parsing engine modules 204 and access modules 206, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 202, for example, that includes instructions executable with the processor 200 or other processor to implement one or more of the features of the module. When any one of the modules includes the portion of the memory that comprises instructions executable with the processor, the module may or may not include the processor. In some examples, each module may just be the portion of the memory 202 or other physical memory that comprises instructions executable with the processor 200 or other processor to implement the features of the corresponding module without the module including any other hardware. Because each module includes at least some hardware even when the included hardware comprises software, each module may be interchangeably referred to as a hardware module, such as the parsing engine hardware module or the access hardware module. The access modules 206 may be access modules processors (AMPs), such as those implemented in the Teradata Active Data Warehousing System®.

The parsing engine modules 204 and the access modules 206 may each be virtual processors (vprocs) and/or physical processors. In the case of virtual processors, the parsing engine modules 204 and access modules 206 may be executed by one or more physical processors, such as those that may be included in the processing nodes 106. For example, in FIG. 1, each parsing engine module 204 and access module 206 is associated with a respective processing node 106 and may each be executed as one or more virtual processors by physical processors 200 included in the respective processing node 106.

In FIG. 2, each processing node 106 is shown as including multiple parsing engine modules 204 and access modules 206, such that there are more parsing engine modules 204 and access modules 206 than processing nodes 106. In one example, during operation, the one or more physical processors 200 included in the processing nodes 106 may execute the parsing engine modules 204 and access modules 206 by switching between the executions of the various modules at a rapid rate allowing the vprocs to substantially operate in “parallel.”

The RDBMS 102 stores data 122 in one or more tables in the DSFs 108. In one example, the data 122 may represent rows of stored tables that are distributed across the DSFs 108 and in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to DSFs 108 and associated access modules 206 by a hash bucket map. The characteristics of the columns chosen for the primary index determine how evenly the rows are distributed.

Rows of each stored table may be stored across multiple DSFs 108. Each parsing engine module 204 may organize the storage of data and the distribution of table rows. The parsing engine modules 204 may also coordinate the retrieval of data from the DSFs 108 in response to queries received, such as those received from a client system 108 connected to the RDBMS 104 through connection with a network 112.

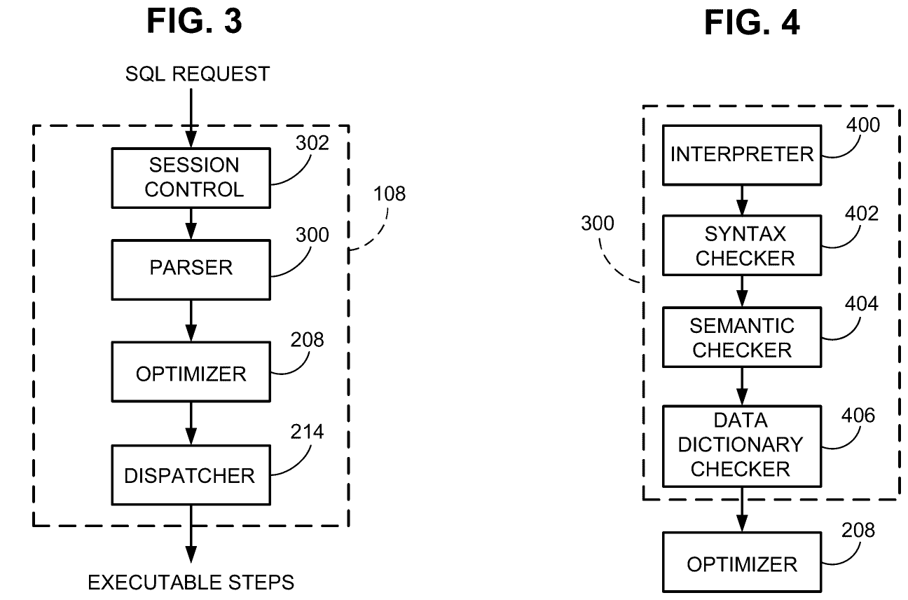

Each parsing engine module 204, upon receiving an incoming database query may apply an optimizer module 208 to assess the best plan for execution of the query. An example of an optimizer module 208 is shown in FIG. 2 with regard to a parsing engine module 204. Additional description of the parsing engine modules 204 is provided with regard to FIGS. 3 and 4. Selecting the optimal query-execution plan may include, among other things, identifying which of the processing nodes 106 are involved in executing the query and which database tables are involved in the query, as well as choosing which data-manipulation techniques will serve best in satisfying the conditions of the query. To this end, for each parsing engine module 204, a parser module 300 (see FIG. 3), and/or optimizer module 208 may access a data dictionary module 210, shown in FIG. 2 specifically for parsing engine module 108 for purposes of illustration.

The data dictionary module 210 may specify the organization, contents, and conventions of one or more databases, such as the names and descriptions of various tables maintained by the RDBMS 104 as well as fields/columns of each database, for example. Further, the data dictionary module 210 may specify the type, length, and/or other various characteristics of the stored tables. The RDBMS 104 typically receives queries in a standard format, such as the structured query language (SQL) put forth by the American National Standards Institute (ANSI). However, other languages and techniques, such as contextual query language (CQL), data mining extensions (DMX), and multidimensional expressions (MDX), graph queries, analytical queries, machine learning (ML), large language modes (LLM) and artificial intelligence (AI), for example, may be implemented in the RDBMS 104 separately or in conjunction with SQL. The data dictionary 210 may be stored in the DSFs 108 or some other storage device and selectively accessed.

The RDBMS 104 may include a workload management system workload management (WM) module 212. The WM module 212 may be implemented as a “closed-loop” system management (CLSM) architecture capable of satisfying a set of workload-specific goals. In other words, the RDBMS 104 is a goal-oriented workload management system capable of supporting complex workloads and capable of self-adjusting to various types of workloads. The WM module 212 may communicate with each optimizer module 208, as shown in FIG. 2, and is adapted to convey a confidence threshold parameter and associated parameters to the optimizer module 208 in communication. Further, the WM module 212 may communicate with a dispatcher module 214 of each parsing engine module 206 (as shown in detail in FIG. 2 for parsing engine module 206) to receive query execution plan costs therefrom, and to facilitate query exception monitoring and automated modifications of confidence threshold parameters in accordance with disclosed embodiments.

The WM module 212 operation has four major phases: 1) assigning a set of incoming request characteristics to workload groups, assigning the workload groups to priority classes, and assigning goals (referred to as Service Level Goals or SLGs) to the workload groups; 2) monitoring the execution of the workload groups against their goals; 3) regulating (e.g. adjusting and managing) the workload flow and priorities to achieve the SLGs; and 4) correlating the results of the workload and taking action to improve performance. In accordance with disclosed embodiments, the WM module 212 is adapted to facilitate control of the optimizer module 208 pursuit of robustness with regard to workloads or queries.

An interconnection (not shown) allows communication to occur within and between each processing node 106. For example, implementation of the interconnection provides media within and between each processing node 106 allowing communication among the various processing units. Such communication among the processing units may include communication between parsing engine modules 204 associated with the same or different processing nodes 106, as well as communication between the parsing engine modules 204 and the access modules 206 associated with the same or different processing nodes 106. Through the interconnection, the access modules 206 may also communicate with one another within the same associated processing node 106 or other processing nodes 106.

The interconnection may be hardware, software, or some combination thereof. In instances of at least a partial-hardware implementation the interconnection, the hardware may exist separately from any hardware (e.g., processors, memory, physical wires, etc.) included in the processing nodes 106 or may use hardware common to the processing nodes 106. In instances of at least a partial-software implementation of the interconnection, the software may be stored and executed on one or more of the memories 202 and processors 200 of the processing nodes 106 or may be stored and executed on separate memories and processors that are in communication with the processing nodes 106. In one example, the interconnection may include multi-channel media such that if one channel ceases to properly function, another channel may be used. Additionally, or alternatively, more than one channel may also allow distributed communication to reduce the possibility of an undesired level of communication congestion among processing nodes 106.

In one example system, each parsing engine module 206 includes three primary components: a session control module 302, a parser module 300, and the dispatcher module 214 as shown in FIG. 3. The session control module 300 provides the logon and logoff functions. It accepts a request for authorization to access the database, verifies it, and then either allows or disallows the access. Once the session control module 302 allows a session to begin, a SQL request may be received such as through submission by a user and the SQL request is routed to the parser module 300.

As illustrated in FIG. 4, the parser module 300 may include an interpreter module 400 that interprets the SQL request. The parser module 300 may also include a syntax checker module 402 that checks the request for correct SQL syntax, as well as a semantic checker module 404 that evaluates the request semantically. The parser module 302 may additionally include a data dictionary checker 406 to ensure that all of the objects specified in the SQL request exist and that the user has the authority to perform the request. The parsing engine module 206 implements the optimizer module 208 to select the least expensive plan to perform the request, and the dispatcher 214 coordinates the runtime execution of executable steps of the query execution plan of the optimizer module 208 with the access modules 206.

In one example, to facilitate implementations of automated adaptive query execution strategies, such as the examples described herein, the WM module 212 monitoring takes place by communicating with the dispatcher module 214 as it checks the query execution step responses from the access modules 206. The step responses include the actual cost information, which the dispatcher module 214 may then communicate to the WM module 212 which, in turn, compares the actual cost information with the estimated costs of the optimizer module 208.

Artificial intelligence (“AI”)-driven techniques may be implemented in the analytic platform 102 allowing more advanced analytic techniques to take place. In one example, AI-driven large language models (“LLMs”) may be used to efficiently address user inquiries. Although many pre-trained models are mostly static (i.e., GPT-4 used by the popular ChatGPT), LLMs may be further trained on domain-specific data. This is especially critical for specialized tasks such as database querying where LLMs are used to answer user inquires and provide suggestions/prompting. Because retraining the model on an expanded full data set is computationally prohibitive, performing “fine-tuning” on a smaller dataset that has been validated for its accuracy and often labeled to support supervised learning is more efficient. Such “supervised fine tuning” results in the model's weights or parameters being adjusted according to the task specific learning.

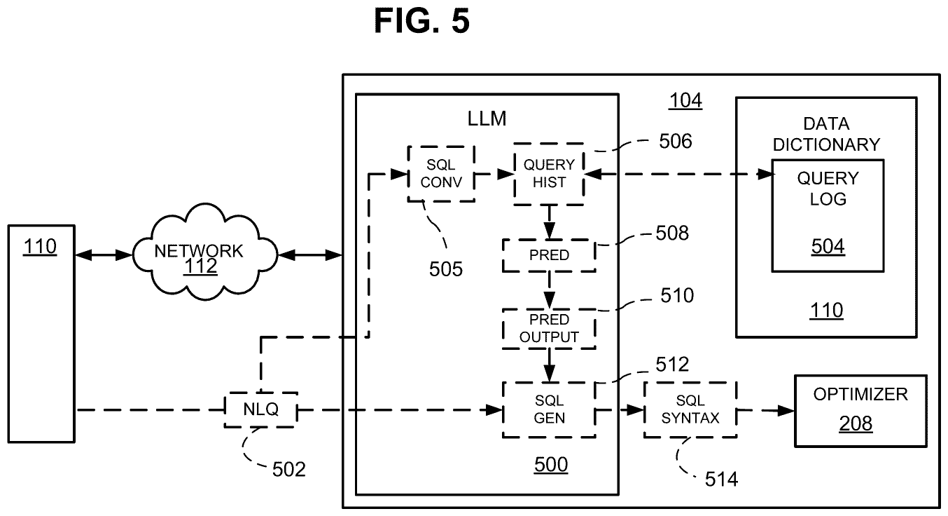

In one example, the analytic platform 102 may implement LLM 500 as shown in FIG. 5 to allow natural language queries (“NLQs”) 502 to be received from the client device 110 and processed. The LLM 500 may be trained to convert NLQs to database language syntax, such as, but not limited to, SQL. While the LLM 500 may recognize the specific data referenced in the NLQ's such as table names, there may be limitations to how accurate the LLM 500 may be even with access to and understanding of metadata. For example, NLQ 502 may reference a table which has a current live version and a backup version, such as from a previous month. These tables may be virtually identical based on metadata, which is what is typically used to identify appropriate tables.

The LLM 500 may use query history data to predict with greater accuracy a proper response to the NLQ 502, such as execution of the NLQ 502 by the RDBMS 104. In one example, a query log 504 may be stored in the data dictionary 210. The query log 504 may provide a record of all queries received by the RDBMS 104. In such a scenario, upon receiving an NLQ 502, the LLM 500 perform SQL conversion 505 to convert the natural language of the NLQ 502 into SQL. Using the SQL version of the NLQ 502, the LLM 500 may retrieve relevant query history 506 from the data dictionary 210. Based on the query history 506, the LLM 500 may perform a prediction 508 as to which table is likely the one referenced in the NLQ 502. Through the prediction output 510, the LLM 500 may engage in SQL generation 512. Generated SQL syntax 514 may then be provided to the optimizer module 208 for query planning.

The LLM 500 may also be used in conjunction with query history to provide proper prompting to a client device, such as the client device 110. In certain instances, a user may seek answers where the user may not be aware of what data is available to help find the answers or not understand how to properly ask the question that will deliver those answers. In order to assist users, the LLM 500 may provide prompts to a user to guide the user to the answer being sought. However, for conversations against data within a database, a unique solution arises. First the user is clearly identified, and the user's rights and roles for the data are available. Additionally, their relationship with others say, in the same department, is also defined. Given that context, and a historical record of all SQL queries issued by this set of individuals, and also against this set of tables which this user has access, provides a starting point for deriving suggestions.

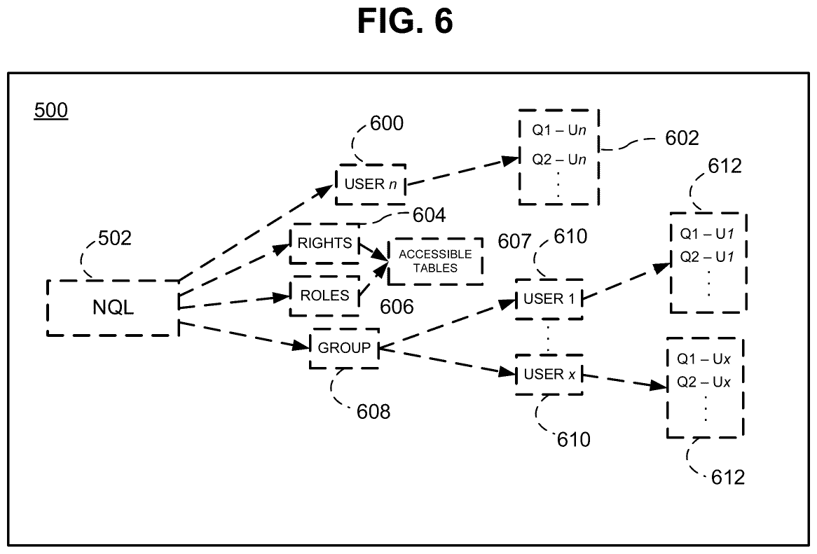

Using the historical SQL queries, which involve a query against a set of tables, the question being asked may be derived. This question can then be used as a prompt or suggestion for the user, where the question is well defined and about the specific data the user may be using the conversational interface to get answers. FIG. 6 is an example of the LLM 500 determining this specific data in generation of the prompt/suggestions for the user. Upon receipt of the NQL 502, the LLM 500 may identify the user 600, designated as user n, where n is some identifier between 1 and x. Through identification of the user 600, the LLM 500 may further identify the queries 602 submitted by the user 600, as well as rights 604 and roles 606 of the user 600. These details may provide information about tables 607 (or other data structures) that are accessible by the user 600. Additionally, the LLM 500 may also identify a group 608 to which the user 600 belongs, such a department within an organization. Identification of the group 608 allows the LLM 500 to also identify other users 610 in the group. In the example of FIG. 6, there may be x number of users, with user 600 being “user n”, where n is between 1 and x. The LLM 500 may identify the queries 612 submitted by other users 610 with the group 608 of user 600.

The information described in FIG. 6, such as the queries 602, 612, rights 604, roles 606, other users 610 allows the LLM 500 to predict which tables are required in order to accurately answer an inquiry from a user via client device 110. Using the historical SQL queries 602, 608, which involve a query against a set of tables, a question to a user may be derived. This question can then be used as a prompt or suggestion for the user via client device 110.

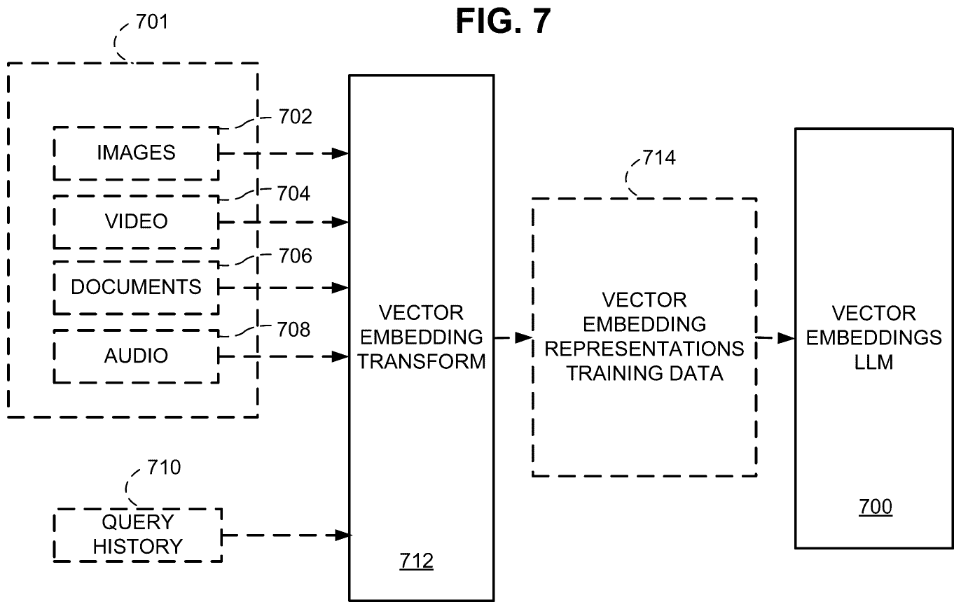

Use of an LLM may be further enhanced through the use of vector embeddings. In one example, query histories may be transformed to vector embeddings allowing use of various techniques (e.g., vector distance, Kmeans clustering, and hierarchical navigable small words (“HNSW”)) to determine similarities against historical data that has also been transformed to vector embeddings. FIG. 7 is an example of an LLM 700 being trained to transform queries from a user to vector embeddings in order to more accurately provide a proper response, be it prompting or providing an actual answer to a query. In one example, general internet training data 701, such as image data 702, video data 704, document data 706, and audio data 708 may be used to train the LLM 700 to a base level. The LLM 700 may be fine-tuned with query history training data 710. The fine tuning allows the LLM 700 to be more accurate with regard to domain-specific scenarios. For example, the LLM 700 can be tailored across a customer base to be specifically suited for each customer's query tendencies and behaviors.

In one example, the general internet training data 701 and query history training data 710 may undergo a vector embeddings transform 712 that converts the different types of data in vector embedding form. The result is vector embeddings representations data 714 that may be used to train the LLM 700 to function as a vector embeddings model. With the vector embeddings LLM 700, query histories may be vectorized and stored in the vectorized form. This allows the vector embeddings LLM 700 to vectorize queries and compare them with the vectorized query history in order to form comparisons. The query vectors may then be placed in clusters. The distance between the query and others within its cluster may be determined. The distance may provide insight on the accuracy of determining the content of the query. First, if the distance is small, this indicates the query is similar to other questions, and thus is likely to be correct. The reverse indicates either: 1) the derived for the natural-language SQL is incorrect, or 2) the query is unusual. Given this rating, the choice can then be made to either request more information rather than returning an answer, or the answer can be returned with a warning that the question is unusual and/or the answer needs to be verified and double checked.

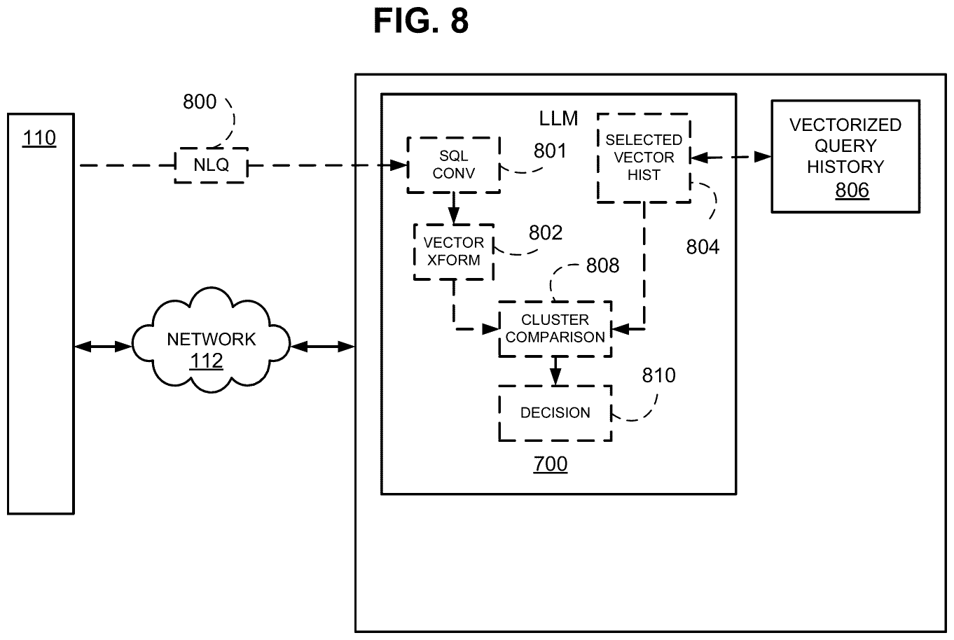

FIG. 8 is an example of the vector embeddings LLM 500 handling a natural language query 800. In one example, the NLQ 800 may be received by the vector embeddings LLM 700 to first be converted to SQL 801 then undergo a vector embedding transform 802. Selected vectorized query history 804 may be taken from vectorized query history records 806 and evaluated by the vector embeddings LLM 700 to perform a cluster comparison 808 with the vectorized NLQ. The vector embeddings LLM 700 may then perform a decision process 810 the proper response, which may include returning a question for more information, informing that the query is unusual, or continuing with the query execution.

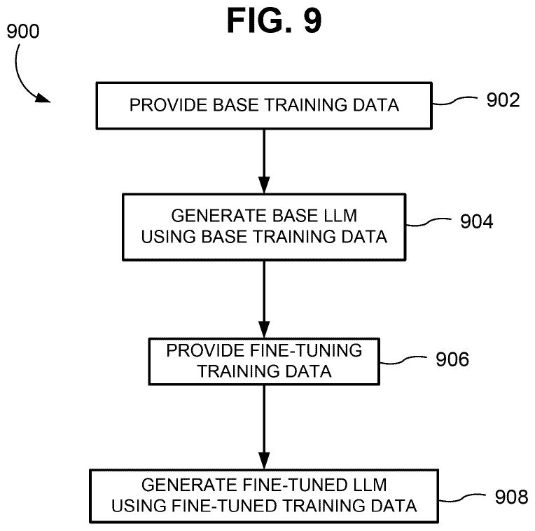

FIG. 9 is an operational flow diagram 900 of a training of an LLM, such as LLM 500. In one example, base training data may be provided to the LLM (902). A base LLM may be generated from the base training data (904). Fine-tuning training data may be provided to the base LLM (906). The fine-tuned LLM may be generated using the fine-tuned training data (908).

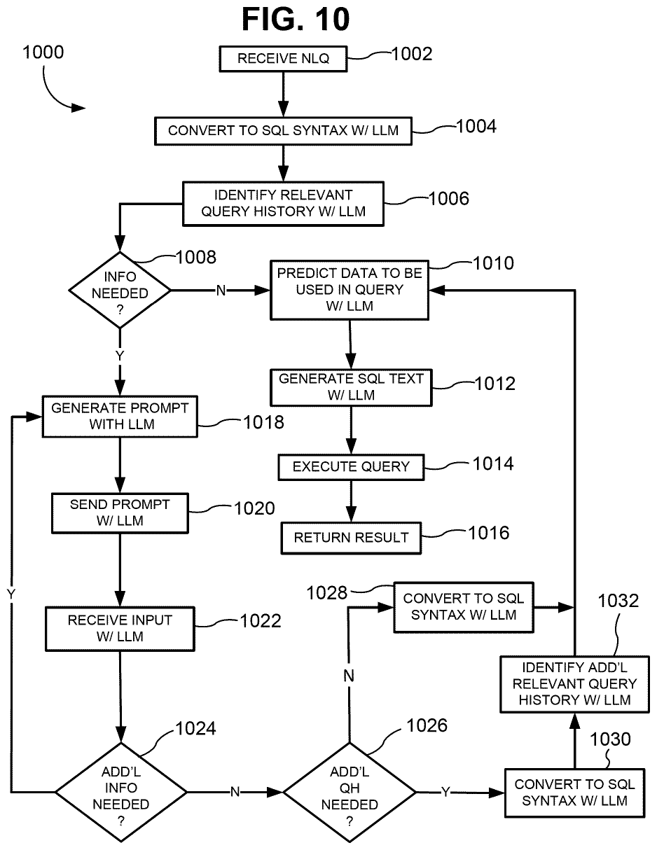

FIG. 10 is an operational flow diagram 1000 of example operation of an RDBMS 104 using an LLM trained to handle natural language queries, such as LLM 500. In one example, the LLM may receive a natural language query (“NLQ”) (1002). The LLM may convert the NLQ into SQL syntax (1004). The LLM may identify relevant query history contained in the query logs (1006). The LLM may determine if information is needed in order to carry out the NLQ (1008). If additional information is not needed, the LLM may predict the data (e.g. tables) needed to carry out the query (1010). The LLM may generate SQL text to carry out the query using the predicted data (1012). The query may then be executed by the RDBMS 104 (1014) and the result returned to a client device (1016), such as the client device 110.

If no information is needed (1008), the LLM may generate a prompt (1018) and send the prompt to the client device (1020). Upon receipt of input from the client device (1022), the LLM may determine if additional information is needed (1024). If additional information is needed, the (1018), (1020), and (1022) sequence may be repeated. If no additional information is needed (1024), the LLM may determine if additional query history in needed (1026). If no additional query history is needed, the additional information obtained by the LLM may be converted to SQL (1028) and used to predict the data needed to execute the NLQ (1010). The SQL text to carry out the NLQ may be generated by the LLM (1012), executed by the RDBMS 104 (1014), and the result may be returned to the client device (1016). If additional query history is needed (1026), the additional information obtained may be converted to SQL syntax (1030) and be used to identify additional relevant query history in the query log (1032). The LLM may then predict the data to be used to execute the NLQ (1010) and generate the corresponding SQL text (1012). The NLQ may then be executed (1014) and the result returned (1016).

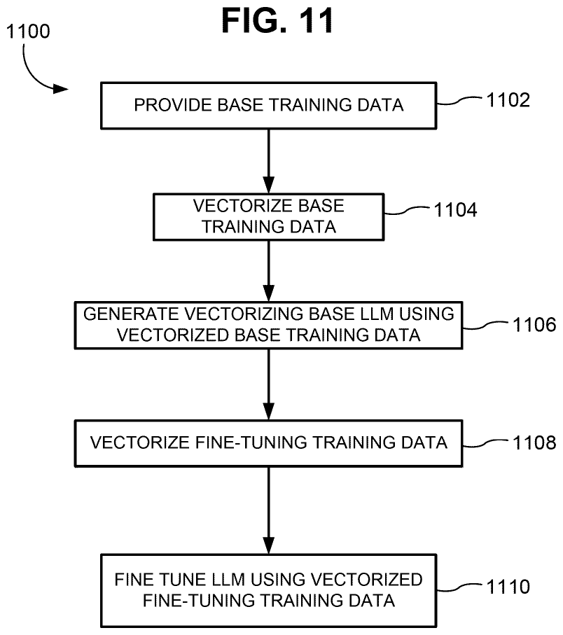

FIG. 11 is an operation flow diagram 1100 of creation of a vector-embeddings LLM, such as the LLM 700. In one example, base training data may be provided (1102). The training data may be transformed to be represented as vector embeddings (1104). A vectorizing base LLM may be generated using the transformed base training data (1106). Training data for fine-tuning may be transformed to be represented as vector embeddings (1108). The vectorizing LLM 700 may be further trained using the fine-tuning vectorized training data (1110).

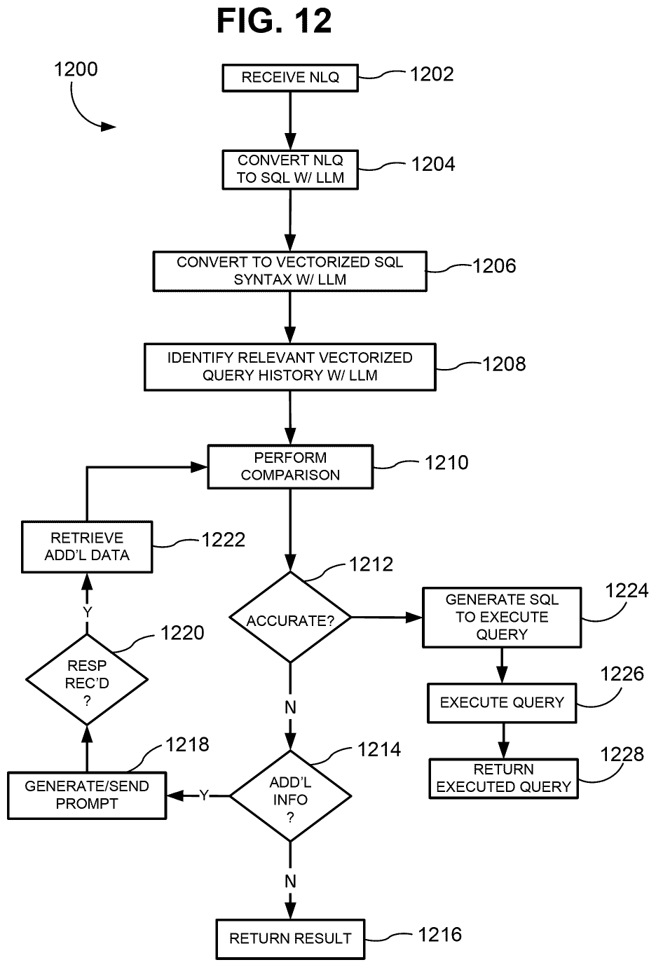

FIG. 12 is an operational flow diagram 1200 of example processing of a NLQ using a vector-embedding LLM (1202), such as the vectorizing LLM 700. In one example, an NLQ may be received (1204), such a NLQ 800. The vectorizing LLM 700 may convert the natural language of the NLQ to SQL (1206). The vectorizing LLM 700 may identify the converted SQL to vector embeddings representation (1208). The vectorizing LLM 700 may identify relevant vectorized query history based on the vectorized SQL (1210). The vectorizing LLM 700 may perform a comparison using various vector embedding distance measuring techniques (1212), such as those previously listed, for example. The vectorizing LLM 700 may determine if the vectorized relevant SQL history is accurate based on the comparison to the vectorized SQL from the NLQ (1214). If the comparison shows inaccuracy, the LLM 700 may determine if additional information is needed (1216). If not, the LLM 700 may generate a response to client device 110 indicating the determined inaccuracy (1218). If additional information is needed (1216), the LLM 700 may generate and send a prompt to the client device 110 request additional information (1218). Upon receipt of a response (1220), the LLM 700 may retrieve additional data (1222), which may also include vectorization of the received additional information and a subsequent comparison made (1210).

If the comparison is accurate, the vectorizing LLM 700 may generate the proper SQL to carry out the query using the correct data (1224). The query may be executed by the RDBMS 104 (1226) and the result returned to the client device 110 (1228).

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

1. A system comprising:
a storage device; and
a plurality of processing nodes, wherein at least one processing node of the plurality of processing nodes is configured to:
receive a natural language query;
deploy a vectorizing large language model (“LLM”), wherein the vectorizing LLM is configured to:
convert the natural language query to a database language syntax representation using decoding constrained by a database language grammar derived from a target database schema;
convert the natural language query to a vectorized natural language representation in the form of an embedding vector;
compare the vectorized natural language representation to vectorized query history information, wherein the comparison is based on vector cluster analysis; and
generate database syntax in response to the natural language query based on the comparison of the vectorized natural language representation to the vectorized query history information by conditioning the LLM on the selected prior queries as exemplars; and
execute the generated database syntax.

2. The system of claim 1, wherein the vectorizing LLM is further configured to compare distances of vector clusters of vectorized query history information with the vectorized natural language representation;

3. The system of claim 1, wherein the vectorizing LLM is further configured to convert the natural language query to a SQL representation.

4. A method comprising:
receiving, with a processor, a natural language query;
deploying, with the processor, a vectorizing large language model (“LLM”), wherein the vectorizing LLM is configured to:
convert the natural language query to a database language syntax representation using decoding constrained by a database language grammar derived from a target database schema;
convert the natural language query to a vectorized natural language representation in the form of an embedding vector;
compare the vectorized natural language representation to vectorized query history information, wherein the comparison is based on vector cluster analysis; and
generate database syntax in response to the natural language query based on the comparison of the vectorized natural language representation to the vectorized query history information by conditioning the LLM on the selected prior queries as exemplars; and
executing, with the processor, the generated database syntax.

5. The method of claim 4, wherein the vectorizing LLM is further configured to compare distances of vector clusters of vectorized query history information with the vectorized natural language representation;

6. The method of claim 4, wherein the vectorizing LLM is further configured to convert the natural language query to a SQL representation.

7. A non-transitory computer-readable medium encoded with a plurality of instructions executable by a processor, the plurality of instructions comprising:
instructions to receive a natural language query;
instructions to deploy a vectorizing large language model (“LLM”), wherein the vectorizing LLM is configured to:
convert the natural language query to a database language syntax representation using decoding constrained by a database language grammar derived from a target database schema;
convert the natural language query to a vectorized natural language representation in the form of an embedding vector;
compare the vectorized natural language representation to vectorized query history information, wherein the comparison is based on vector cluster analysis; and
generate database syntax in response to the natural language query based on the comparison of the vectorized natural language representation to the vectorized query history information by conditioning the LLM on the selected prior queries as exemplars; and
instructions to execute the generated database syntax.

8. The non-transitory computer-readable medium of claim 7, wherein the vectorizing LLM is further configured to compare distances of vector clusters of vectorized query history information with the vectorized natural language representation;

9. The non-transitory computer-readable medium of claim 7, wherein the vectorizing LLM is further configured to convert the natural language query to a SQL representation.
